(19) United States
(12) Patent Application Publication
(10) Pub. No.: US 2024/0348513 A1
(43) Pub. Date: Oct. 17, 2024

(54) SLICE-DRIVEN DEPLOYMENT OF NETWORK FUNCTIONS

(71) Applicant: Microsoft Technology Licensing, LLC, Redmond, WA (US)

(72) Inventors: Ronald Mark PARKER, Manchester, MA (US); Mark Gordon LIBBY, Groton, MA (US); Michael Anthony BROWN, McKinney, TX (US); Haibo QIAN, Frisco, TX (US); Rahul BOSE, Westford, MA (US)

(21) Appl. No.: 18/301,885

(22) Filed: Apr. 17, 2023

(51) Int. Cl. H04L 41/5054; H04L 41/5051; H04W 4/50; H04W 24/02

(52) U.S. Cl. CPC H04L 41/5054; H04L 41/5051; H04W 4/50; H04W 24/02

(57) ABSTRACT

The present disclosure relates to systems, methods, and computer readable media for facilitating placement of network functions based on a network slice profile that is received and based on internal knowledge of a cloud computing system having network resources thereon. The systems described herein involve tagging the network resources with various characteristics, generating resource management profiles including instructions that may be used to supplement information from the slice profile(s), and matching an incoming slice profile with a resource management profile. The systems described herein facilitate rolling out a deployment of network functions on the network resources in accordance with information from the resource management profile in a way that optimizes resources and allows automated placement of network functions based on a received network slice.

### BACKGROUND

Cellular networks can provide computing devices (e.g., mobile devices) with access to services available from one or more data networks. A cellular network is typically distributed over geographical areas that often include base stations, core networks, and/or edge networks that collectively provide a variety of services and coverage to end-user devices (e.g., mobile devices). The devices of the cellular network provide reliable access to a data network by mobile devices over a wide geographic area. In many instances these cellular networks provide mobile devices access to the cloud.

As noted above, cellular networks include a number of network components. For example, cellular networks often include a radio access network (RAN), an edge network, and a core network. In many instances, the RAN may include base stations having components thereon that communicate wirelessly with user devices (e.g., mobile devices or other endpoints) and facilitate interaction with other components of a core network and/or cloud computing system. In addition, the core network may include a variety of resources and nodes that provide services to clients.

In recent years, cellular networks have provided a variety of network services that enhance capabilities of resources and devices on a cellular network. For example, many core networks provide access to a variety of network functions having a wide variety of configurations that control how the network functions operates within a respective computing environment. In addition, network functions may have different applicable configurations based on where a network function is implemented geographically, the specific hardware on which the network function is deployed, preferences of individual customers with respect to specific deployments, as well as other factors. This increased complexity and scale is often limited by conventional deployment methods. For example, conventional techniques for deploying or placing functions are often inflexible and result in ineffective use of network resources. In addition, many conventional systems require each network function to be individually configured by a customer. As a result, conventional approaches to deploying network functions are often non-scalable, inflexible, time-consuming, and prone to inaccuracies and inefficiencies.

These and other problems exist in connection with deploying and configuring network functions across a communication network.

### BRIEF DESCRIPTION OF THE DRAWINGS

FIG. 1 illustrates an example environment including an implementation of a slice-driven request management system for placing network functions based on information contained within a network slice.

FIG. 2 illustrates an example implementation of the slice-driven request management system for placing network functions based on a network slice and resource management profiles.

FIG. 3 illustrates an example placement of network functions based on a match between a network slice of a deployment request and corresponding resource management profile.

FIG. 4 illustrates another example placement of network functions based on a match between a network slice of a deployment request and corresponding resource management profile.

FIG. 5 illustrates an example series of acts for orchestrating deployment of network functions based on a determined match between a network slice and a resource management profile.

FIG. 6 illustrates certain components that may be included within a computer system.

### DETAILED DESCRIPTION

The present disclosure relates to systems, methods, and computer readable media for facilitating placement of network functions based on network slice profiles that are received within deployment requests. In particular, as will be discussed in further detail below, the present disclosure relates to processing a deployment request that includes a network slice profile (or simply “network slice”) that specifies one or more service requirements to be satisfied by a placement of network resources responsive to the deployment request. This disclosure involves leveraging internal information about network resources to generate resource management profiles. As will be discussed below, these resource management profiles include instructions for placing network functions in a manner which optimizes utilization of network resources, and which provides a scalable approach to deploying or otherwise placing network functions across deployment areas of a cloud computing system.

As an illustrative example, a slice-driven request management system may be implemented in a telecommunications environment for orchestrating deployment of network functions based on a configuration received by a control system including a network slice. In one or more embodiments, the slice-driven request management system generates a plurality of resource management profiles associated with deploying network functions. The resource management profiles include instructions being determined based on tags that have been associated with resources on a cloud computing system (e.g., a telecommunications network, such as a 5^{th} generation (5G) telecommunications network). The slice-driven request management system receives a deployment request having a network slice profile indicating one or more service requirements associated with fulfilling the deployment request. The slice-driven request management system may match the deployment request to a corresponding resource management profile. The slice-driven request management system may orchestrate a deployment of network functions on the cloud computing system based on the instructions included within the resource management profile.

The present disclosure includes a number of practical applications that provide benefits and/or solve problems associated with rolling out or otherwise orchestrating deployment of network functions across one or more deployment areas of a telecommunications network. Some example benefits are discussed herein in connection with various features and functionalities provided by a slice-driven request management system. It will be appreciated that benefits discussed herein are provided by way of example and are not intended to be an exhaustive list of all possible benefits of the slice-driven request management system.

Features and functionality of the slice-driven request management system provide a mechanism whereby requesting resources and deploying network functions on said resources can be performed automatically (e.g., without receiving user input beyond a network slice profile). For example, by generating resource management profiles that include specific deployment instructions therein, the slice-driven request management system facilitates deploying any number of network functions having specific configurations associated therewith in response to a request based on information contained within a network slice. Thus, as will be discussed below, the network slice may provide some service requirements while the resource management profile provides additional or supplemental information that is used in orchestrating deployment (e.g., preparing for deployment, rolling out network functions, and/or generating deployment instructions).

In addition to automating portions of the rollout process, the slice-driven request management system leverages internal knowledge of a cloud computing system, telecommunications network, and associated resources to optimize utilization of the network resources in responding to a resource request. For example, one or more embodiments described herein involve tagging network resources with metadata indicating certain characteristics of the respective resources (or groups of resources, such as clusters, datacenters, etc.). These tags may be associated with or used in generating the resource management profiles, providing context for deployment instructions included with the respective profiles, which may be used in efficiently rolling out network functions in response to a resource request.

In addition to providing an efficient and optimized approach to rolling out network functions, the slice-driven request management system additionally enables users to indicate preferences of tags or resource types or other deployment instructions that may be used in fulfilling a resource request. For example, a user may establish a preference of deploying a large (e.g., greater than or equal to a threshold) number of small-sized network functions at edge locations for certain types of requests. Other users may establish a preference of deploying a smaller number (e.g., less than or equal to a threshold) of large or high-capacity network functions at a central (or edge) location for other types of requests. Indeed, as will be discussed below, these resource management profiles may be customizable and configurable to accommodate a wide range of preference and customer needs when deploying network functions in a telecommunications network.

The slice-driven request management system may additionally leverage the knowledge base of a large set of users that have created, added, and/or modified resource management profiles over time. For example, as more resource management profiles are added to a corpus of profiles that may be considered in determining a specific set of deployment instructions responsive to a resource request, the slice-driven request management system may provide an increasing number of these resource management profiles to a diverse user base associated with an increasing variety of resource requests. Indeed, as the number of profiles increases, the variety of instructions may similarly increase in size and complexity to accommodate a larger variety of resource requests. This scaling provides value as new resources are added, new network function types are onboarded, and the size of deployments (e.g., the number of network functions) grows over time as demand for cloud computing resources, particularly in the field of telecommunications networks, continues to grow.

The features described herein in connection with the slice-driven request management system are applicable to both existing resources as well as new resources that are added to a telecommunications network. For example, as will be discussed below, network resources may be tagged as they are added or onboarded to a new or existing network. In addition, or as an alternative, resources that are already running may similarly be tagged. Further, tags may be added over time as a demand for particular characteristics of resources are discovered or added to the types of characteristics that may be considered in generating new resource management profiles and/or updating existing resource management profiles. These resource tags may be broad or specific and may be associated with different hierarchies of a network. This flexibility in tagging to different layers of the network as well as different characteristics of the resources themselves provides a flexible and configurable approach to generating and utilizing these resource management profiles in more effectively and efficiently utilized networking resources in a telecommunications network.

As illustrated in the foregoing discussion, the present disclosure utilizes a variety of terms to describe features and advantages of a slice-driven request management system within a variety of computing environments. Additional detail will now be provided regarding the meaning of some of these terms.

As used herein, a “cloud computing system” or “distributed computing system” may be used interchangeable to refer to a network of connected computing devices that provide various services to computing devices (e.g., customer devices). For instance, as mentioned above, a cloud computing system can include a collection of physical server devices (e.g., server nodes) organized in a hierarchical structure including clusters, computing zones, virtual local area networks (VLANs), racks, fault domains, etc. In one or more embodiments described herein a portion of the cellular network (e.g., a core network) may be implemented in whole or in part on a cloud computing system. In one or more embodiments a data network may be implemented on the same or on a different cloud computing network as the portion of the cellular network.

As used herein, a “telecommunications network” may refer to a system of interconnected devices that are distributed over geographical areas and which provide communication and data capabilities to end-user devices (e.g., mobile and non-mobile devices). In one or more embodiments described herein, a telecommunications network refers to a cellular network that includes radio access network (RAN) components, core network components, and network functions implemented on server nodes on the cellular network. In one or more embodiments described herein, the telecommunications network refers specifically to a 5G network environment; however, other implementations may include previous generations or future generations that make use of network functions implemented on computing devices of the telecommunications network.

As used herein, a “network function” may refer to an entity in a telecommunications network that provides access to one or more services or applications of the telecommunications network. A network function may refer to one of a wide variety of network function types corresponding to different unique or defined functions or services that may be provided via the telecommunications network. As will be discussed in connection with various examples, a network function may refer to a physical function, virtual network function, or any of a variety of types of network functions. Examples of network functions include, but are not limited to, session management functions (SMFs), user plane functions (UPFs), access and mobility management function (AMF), and any other type of function that can be implemented within a telecommunications network. Indeed, in one or more embodiments, a network function may refer to any function or entity in a telecommunications network (e.g., 2G, 3G, 4G, 5G or beyond cellular environment) that provides access to a service and/or application to a client of the telecommunications network.

As used herein, a “request” or “deployment request” may refer to an expression of intent or command to deploy one or more network functions on the telecommunications network. In one or more embodiments described herein, a request includes a network slice or a network slice profile (or simply “slice profile”) included therein. As used herein, a network slice refers to a profile that indicates one or more service requirements and/or parameters for fulfilling a deployment request. For example, a network slice may indicate a type or class of service (e.g., mobile broadband, ultra-low latency). A network slice may include other requirements of a requested service, such as service level agreements (SLAs), quality of service (QOS) requirements, security requirements, capacity requirements (e.g., a number of supported sessions), an indication of whether a service can be shared or not, and other characteristics or requirements of a service deployment. Indeed, a slice profile may include a combination of multiple of the above requirements (e.g., a network slice that requires a number of sessions at a corresponding latency). In one or more embodiments, a network slice is a standards-based construct. For example, in one or more implementations described herein, a network slice includes service requirement information in accordance with 3GPP standards.

As used herein, a “deployment area” may refer to an area within a telecommunications network within which a network function is deployed. In one or more embodiments, a deployment area may refer specifically to a geographic area, such as a datacenter, a geographic region, a cluster (or group of clusters) of devices, an edge network, or other physical, logical, or geographic grouping of devices. In one or more embodiments described herein, a deployment area refers to any grouping of devices as defined within a resource management profile. Indeed, a deployment area may refer to any grouping (e.g., physical or virtual) or slice of a telecommunications network as defined within a corresponding model (e.g., a topographical or hierarchical model of the network). A deployment area may refer to a small number of devices (e.g., a specific server rack) or, alternatively, may refer to a large grouping of devices (e.g., an entire datacenter, a set of multiple datacenters, a tracking area, a set of tracking areas).

In one or more embodiments described herein, network resources are associated with resource tag. As used herein, a “resource tag” refers to any characteristics or combination of characteristics associated with a resource or set of multiple resources. For example, a tag may refer to certain capabilities of a network resource, a storage or processing capacity of a network resource, a number of allocatable cores on a particular network resource (or group of resources), a location (e.g., a geographic location) of a resource or set of resources, an indication of network function types that may be deployed on said resource(s), security metrics of a resource, bandwidth capacity of a group of resources, or any other characteristic (or combination of characteristics) that may be associated with a corresponding set of one or more resources.

In one or more embodiments, tags are associated with hierarchical groupings of resources. For example, a datacenter may be associated with one or more tags that are applicable to all resources within the datacenter, while lower-level resources (e.g., clusters, racks, individual servers) may similarly be associated with tags that are associated with different groupings of resources within the hierarchical grouping(s) of resources. In addition, tags may be associated with physical or logical groupings of network resources.

As used herein, a “resource management profile” refers to a set of preferences, parameters, and other instructions that are based at least in part on resource tags. For example, a resource management profile may include a set of instructions for rolling out a network function (or set of network functions) to a specific set of target resources based on tags that have been previously associated with the target resources. A resource profile may indicate a specific set of optimizations (e.g., low latency tags, tags indicating a range of tracking locations, tags indicating a set of capabilities or compatible services). A resource profile may be more generic, such as indicating a type of service (e.g., gaming apps) in which latency tags are prioritized when rolling out a deployment. A resource profile may be more specific to a user or requesting entity. In one or more embodiments, a resource management profile may include information indicating what network functions to deploy, and not simply the size and number of network functions. To illustrate, a resource management profile may include instructions that only user plane functions (UPFs) should be deployed in order to satisfy requirements of a particular network slice profile. A resource profile may be one of a collection of profiles that have been added to a corpus of available profiles that can be matched to an incoming request.

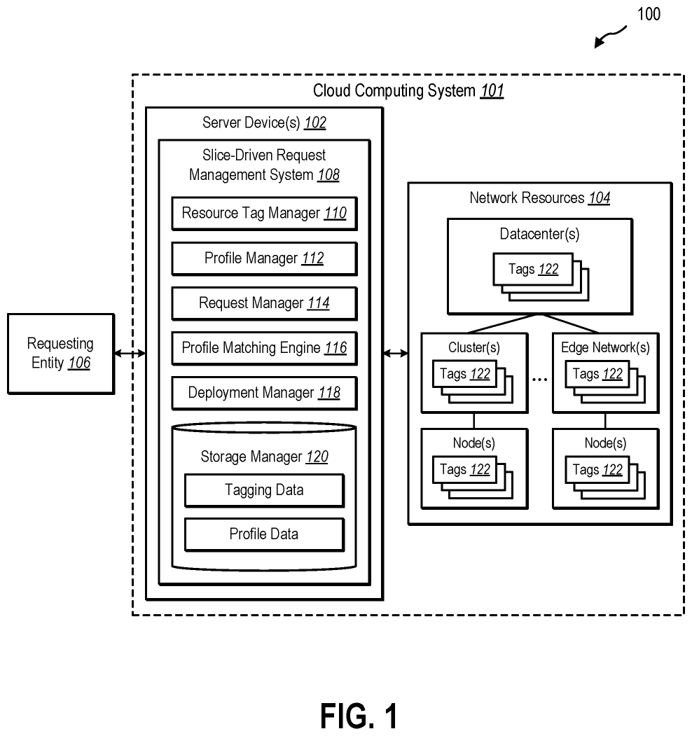

Additional detail will now be provided regarding implementation of a slice-driven request management system in relation to illustrative figures portraying example implementations. For example, FIG. 1 illustrates an example environment 100 including a cloud computing system 101 on which a telecommunications network can be implemented. As shown in FIG. 1, the cloud computing system 101 includes one or more server device(s) 102 and network resources 104. In one or more embodiments, the server device(s) 102 and network resources 104 are implemented within a core network of a cellular communication network, such as a fourth generation (4G) network, 5G network, or future generation(s) of telecommunications network. Indeed, while one or more embodiments described herein refer to implementations of a slice-driven request management system implemented within a 5G telecommunications network, it will be appreciated that features and functionality of the slice-driven request management system may be implemented within a variety of telecommunications networks, including 4G, 5G, and future generations of telecommunications networks in which resource requests can be received and processed in accordance with one or more embodiments described herein.

As shown in FIG. 1, the environment 100 includes a requesting entity 106 in communication with the server device(s) 102. The requesting entity 106 may be implemented on a computing device, such as a client device that communicates with the server device(s) 102 and obtains access to network resources 104 on the cloud computing system 101. The requesting entity 106 may be implemented on a client device, which may include (by way of example) a mobile device such as a mobile telephone, a smartphone, a personal digital assistant (PDA), a tablet, or a laptop. Alternatively, a client device may refer to non-mobile devices such as a desktop computer, a server device (e.g., an edge network server), or other non-portable devices. In one or more embodiments, the a client device refers more generally to any endpoint capable of communicating with devices on a cloud computing system 101, such as Internet of Things (IoT) devices, or other Internet-enabled devices. In one or more embodiments, the requesting entity 106 is implemented as an application or software construct on one or more computing devices.

As shown in FIG. 1, the server device(s) includes a slice-driven request management system 108. The slice-driven request management system 108 may include a resource tag manager 110, a profile manager 112, a request manager 114, a profile matching engine 116, and a deployment manager 118. The slice-driven request management system 108 may additionally include a data storage 120 providing access to a variety of information (e.g., tagging data, profile data) to one or more of the components 110-118 of the slice-driven request management system 108. Additional information in connection with the respective components 110-118 of the slice-driven request management system 108 will be discussed in further detail below.

As further shown, the cloud computing system 101 includes a variety of network resources 104. These network resources 104 may be deployed across one or more datacenters. As noted above, the network resources 104 may refer to computing, storage, or other types of resources that are implemented on server nodes, which may be implemented on certain groupings of server nodes, such as (by way of example) node clusters and/or edge networks. In one or more embodiments, the network resources 104 are implemented across different deployment areas (e.g., geographical and/or virtual groupings of server resources). As used herein, network resources 104 may refer to different groupings of network resources (e.g., datacenters, clusters, edge networks) or individual resources (e.g., server nodes, compute cores). As shown in FIG. 1, the network resources 104 have any number of resource tags 122 (or simply “tags 122”) associated therewith indicating one or more characteristics of the respective network resources 104. Assignment and utilization of these resource tags 122 will be discussed in further detail below.

As shown in FIG. 1, the requesting entity 106 may be in communication with the server device(s) 102 via a network or other wireless communication medium. While not shown in FIG. 1, the requesting entity 106 may communicate with the components of the cloud computing system 101 via a radio access network (RAN), such as through one or more base stations in communication with a core network. In one or more embodiments, the environment 100 refers to a telecommunications environment in which components of the RAN and core network are implemented as virtualized components on server nodes within the cloud computing system 101 (e.g., on server nodes of an edge location of the cloud computing system 101).

As shown in FIG. 1, and as will be discussed in further detail below, the requesting entity 106 may generate and provide a resource request to the slice-driven request management system 108. The resource request may include a network slice profile indicating one or more service requirements to be satisfied in deploying network functions on the network resources 104 of the cloud computing system 101. As noted above, the network slice profile indicates one or more requirements of a requested service (or multiple services) that should be satisfied in a determined rollout of network functions on the network resources 104 of the cloud computing system 101. As will be discussed in further detail below, the slice-driven request management system 108 may receive and process the resource request in accordance with one or more embodiments described herein and based at least in part on the resource tags 122 that are associated with the respective groupings of network resources 104.

Additional details will now be discussed in connection with the respective components 110-120 of the slice-driven request management system 108. For example, as shown in FIG. 1, the slice-driven request management system 108 includes a resource tag manager 110. The resource tag manager 110 may associate, assign, or otherwise tag individual network resources 104 and/or groupings of network resources 104 with resource tags 122. As noted above, the resource tags 122 may include tagged characteristics or features of various computing resources that are usable on the cloud computing system 101. The resource tags 122 may be associated with the respective resources at a time when the network resources 104 are onboarded to the cloud computing system 101. The resource tags 122 may be associated with the respective resources after they have been rolled out and implemented within the framework of the cloud computing system 101.

As shown in FIG. 1, the slice-driven request management system 108 further includes a profile manager 112. The profile manager 112 may generate, update, or otherwise maintain a collection of resource management profiles for any number of users or accounts of the cloud computing system 101. These resource management profiles may include instructions indicating preferences, priorities, policies, or other information that may be used in determining how requested resources can be rolled out and implemented on the network resources 104. The resource management profiles may include indicators of various resource tags, which are considered or otherwise relied on in determining how to allocate network resources 104 in an efficient and effective manner while satisfying requirements indicated within a received network slice profile.

As further shown in FIG. 1, the slice-driven request management system 108 includes a request manager 114. The request manager 114 may be tasked with receiving and processing a received request. For example, the request manager 114 may identify a network slice profile and identify service requirement(s) indicated within the network slice profile. In one or more embodiments, the request manager 114 includes an application programming interface (API) that is used to process a request and parse instructions included therein.

As shown in FIG. 1, the slice-driven request management system 108 includes a profile matching engine 116. Upon receiving and parsing a resource request, the profile matching engine 116 may determine one or more resource management profiles that match a network slice profile of the received request. In one or more embodiments, the profile matching engine 116 determines a specific resource management profile having instructions that fulfil the requirements indicated by a received network slice profile while optimizing computing and/or storage resources on the cloud computing system 101. This matching of a network slice with a corresponding resource management profile may be based on a direct comparison of the network slice and the information contained within the resource management profiles. In one or more implementations, the profile matching engine 116 maintains a set of policies or algorithms for mapping a received slice profile with a corresponding resource management profile.

The slice-driven request management system 108 additionally includes a deployment manager 118. The deployment manager 118 may determine or otherwise identify a set of actions to perform based on the instructions from the identified resource management profile. For example, the deployment manager 118 may generate a set of deployment instructions and cause a set of network functions to be deployed on the network resources 104 in accordance with the instructions contained within the identified resource management profile. In some examples, the deployment manager 118 adds the deployment instructions or to a queue, a profile, or other object that can be used by other resources of the cloud computing system 101 in rolling out network functions on the cloud computing system 101 (e.g., at a later time).

As further shown, the slice-driven request management system 108 includes a data storage 120. The data storage 120 includes various types of data maintained on the server device(s) 102 (or on a separate device accessible to components of the slice-driven request management system 108). As shown in FIG. 1, the data storage 120 includes tagging data. The tagging data includes any information associated with resource tags that have been associated with respective resources or groups of resources from the collection of network resources 104 on the cloud computing system 101. The tagging data may refer to metadata that is maintained on the respective network resources 122. In one or more embodiments, the tagging data refers to metadata or other tags that are maintained in a tagging record (not shown) that is accessible to one or more of the components 110-118 of the slice-driven request management system 108. As noted above, the tagging data may be relied on in generating the resource management profiles as well as matching a received network slice profile with a corresponding resource management profile. The tagging data may be updated over time as additional tags are discovered and/or associated with the respective resources or as additional resources are added to the cloud computing system 101.

The storage data 120 may additionally include profile data. The profile data includes any information associated with the resource management profiles. For example, the profile data may include tags that are included with resource management profiles. The profile data may include certain preferences or priorities associated with the tags, such as which tags should be prioritized over other tags when rolling out a deployment of resources. The resource management profiles may indicate specific users or accounts that are associated with the respective profiles. For example, a resource management profiles may be associated with a user that created the profile or may be identified by a user as a preferred profile when processing resource requests of a certain type or category.

It will be understood that each of the components 110-118 of the slice-driven request management system 108 provides different features and functionalities described herein in connection with tagging resources, receiving and processing resource requests, and causing network functions to be deployed on network resources in accordance with one or more embodiments described herein. It will be noted that while certain components are described in connection with software or hardware modules implemented on a single server device (e.g., server device(s) 102), one or more of the components 110-118 may be implemented across a plurality of devices. By way of example and not limitation, the resource tag manager 110 and/or profile manager 112 or functions associated with tagging resources and generating resource management profiles may be implemented on different devices as additional components 114-118 or functions associated with receiving and processing a resource request. In addition, some of the features described herein in connection with individual components may be performed by different components or in cooperation with other components of the slice-driven request management system 108.

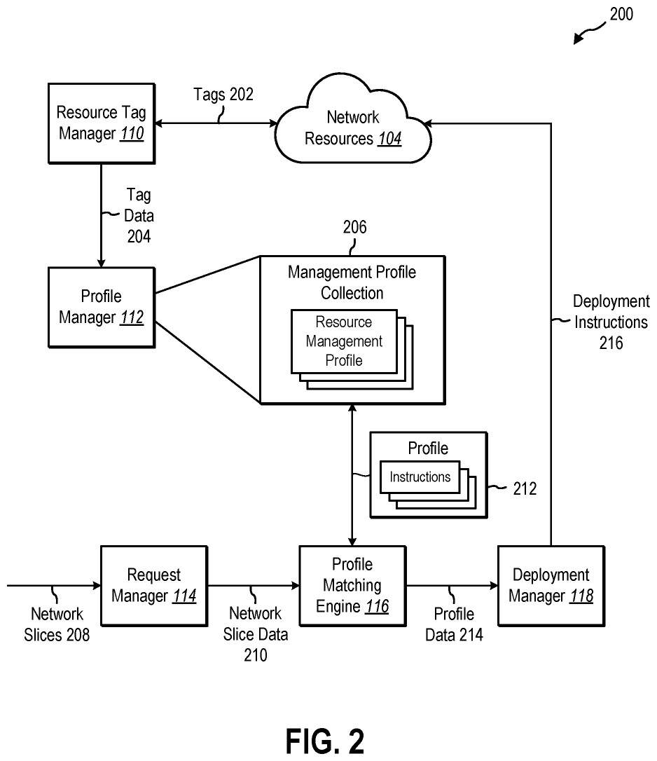

Additional information will now be discussed in connection with an example implementation of the slice-driven request management system 108 in tagging network resources, maintaining resource management profiles, and determining an efficient deployment plan (e.g., deployment instructions, a deployment goal state) associated with rolling out one or multiple network functions based on a resource request in a manner that satisfies a network slice profile included within the resource requires. In particular, FIG. 2 illustrates an example workflow 200 in which components of the slice-driven request management system 108 discussed above in connection with FIG. 1 receives and processes a resource request in accordance with one or more embodiments.

As shown in FIG. 2, a resource tag manager 110 generates a plurality of tags 202 with respect to a plurality of network resources 104. In one or more embodiments, the resource tag manager 110 evaluates each resource or grouping of resources (e.g., each server, rack, cluster, etc.) to determine a characteristic attributable to the particular resource(s). Upon determining this characteristic, the resource tag manager 110 assigns a tag (e.g., metadata) to the resource(s) and associates the resource with the particular tag. In one or more embodiments, the resource tag manager 110 provides the tags 202 to the network resources 104 to maintain on the respective resources. In one or more embodiments, the resource tag manager 110 generates or maintains a record of the tags 202 to be accessed by one or more components of the slice-driven request management system 108.

The specific network resources 104 (or groupings of resources) may be associated with any number of tags. For example, a first network resource may be associated with a capacity tag indicating a storage and/or processing capacity of the first network resource. The first network resource may similarly be associated with a latency tag, bandwidth tag, and a security tag indicating latency speeds, bandwidth capacity, and security information associated with the first network resource. Where the first network resource is part of a larger group of resources (e.g., an edge network, a datacenter, a deployment area), the first resource tag may also be associated with a tag that is attributable or otherwise assigned to the associated group of resources.

As noted above, the resource tag manager 110 may associate the tags 202 with the respective network resources 104 at any point in the lifecycle of the network resources 104. For example, the resource tag manager 110 may associate one or more network tags with a particular resource when the resource is added to the framework of the cloud computing system 101. Alternatively, the resource tag manager 110 may associate one or more network tags with a resource that has previously been onboarded to the cloud. Further, the resource tag manager 110 may update the resource tag(s) 202 at any point during the lifecycles of the network resources 104. In one or more embodiments, as additional characteristics become or known or when additional criteria is being considered in optimizing rollouts or deployments or in generating/updating resource management profiles, additional tags may be added to one or more network resources 104 over time.

As shown in FIG. 2, the resource tag manager 110 may provide tag data 204 to the profile manager 112 for use in generating a management profile collection. As noted above, the profile manager 112 may generate resource management profiles based at least in part on the tags that provide internal knowledge of the network resources 104. For example, the profile manager 112 may generate resource management profiles that indicate preferences, priorities, and other instructions for rolling out network functions based on known resource tags that exist and have been associated with various groupings of network resources 104.

As an illustrative example, a resource management profile (e.g., profile 212) may include instructions indicating certain tags that should be prioritized in response to a service type indicated by a network slice. For instance, where a network slice indicates a mobile broadband resource request, a matching resource management profile may be selected based on an indication of a preference to deploy a high number (e.g., higher than a threshold number) of network functions of a particular size across multiple deployment areas (e.g., across multiple edge networks).

As another example, a resource management profile (e.g., profile 212) may include instructions indicating certain tags or instructions that should be considered in response to a network slice indicating a required storage or processing capacity that is not accompanied by a specific latency requirement. In this example, a matching resource management profile may be identified that includes instructions indicating deployment of a single high capacity network function (or a low threshold number of high capacity network functions) on a central resource, such as a datacenter (e.g., rather than on an edge location.

The management profile collection 206 may include any number of resource management profiles associated with any number of users (e.g., profile creators). The resource management profiles may include any combination of instructions giving broad or narrow latitude in how a network slice profile can be processed. The management profile collection 206 may be added to and updated over time, providing a larger and dynamic collection of resource management profiles having further optimized and/or more specific instructions that comply with a wide variety of service requirements that are indicated by any received network slice profile.

While the acts of associating the resource tags and generating the management profile collection 206 can be updated periodically, in one or more embodiments, these acts of tagging the resources and generating the resource management profiles may be performed prior to receiving and processing a resource request in accordance with one or more embodiments. In this example, after generating the management profile collection 206, the request manager 114 receives a resource request including a network slice 208. As noted above, the network slice 208 may include information indicating any number of service requirements to be satisfied by a deployment of network functions. In one or more embodiments, the network slice profile includes service requirement information that is specified in accordance with 3GPP standards.

The request manager 114 may process or parse the received request. For example, in one or more embodiments, the request manager 114 parses the network slice(s) 208 included with the resource request(s) to determine one or more service requirements indicated therein. As noted above, the network slice 208 is a standard-defined construct, which the request manager 114 is configured to understand in determining network slice data 210 to use in determining a resource management profile that would satisfy requirements of the network slice 208 and would optimize utilization of the network resources 104.

As shown in FIG. 2, the request manager 114 provides the network slice data 210 to a profile matching engine 116. Upon receiving the network slice data 210, the profile matching engine 116 may determine a matching profile 212 from the management profile collection 206. As noted above, the profile matching engine 116 may consider criteria or instructions included within the respective management resource profiles to determine which of the management resource profiles best matches the combination of service requirements indicated within the received network slice 208.

Indeed, as illustrated in a plurality of illustrative examples below, matching between resource management profiles and a received network slice may be based on a wide variety of factors and based on varying levels of specificity. For example, matching may be a course comparison such that any network slice that matches a specific service type is matched with a corresponding resource management profile pre-associated with the specific service type. The matching may also be a granular comparison in which a particular combination of signals (e.g., service type, number of protocol data unit (PDU) sessions, geographic location) is considered in determining a matching resource management profile.

As an illustrative example, in one or more embodiments, the profile matching engine 116 matches a received network slice 208 with the matching profile 212 based on a location indicated within the network slice 208. For example, the network slice 208 may indicate a specific deployment area or range of deployment areas, which the profile matching engine 116 may use to identify one or more resource management profiles that have been associated with the identified area(s) or locations. In this example, the profile matching engine 116 may identify a location-specific resource management profile that best matches the location criteria (as well as other criteria indicated within the network slice 208).

As another example, the profile matching engine 116 may determine a matching profile 212 based on one or more preferences of a requesting entity. In this example, the profile matching engine 116 may identify a set of resource management profiles having certain instructions or rules that match preferences of the requesting entity, such as a preference of location, security requirement(s), quality of service criteria, or other individual preferences. The profile matching engine 116 may then identify the matching profile 212 from those resource management profiles that correspond or align with the indicated requesting entity preferences.

In one or more embodiments, the profile matching engine 116 maintains policies, priorities, and other criteria to use in matching specific resource management profiles with a received network slice. The criteria or rules may be specific to certain types of services. For example, a gaming network slice may be associated with a policy that directs that profile matching engine 116 to match any gaming network slices with a corresponding resource management profile (or set of profiles) that include deployment instructions that optimize various requirements that are commonly associated with gaming slices. As another example, a different type of network slice (e.g., a storage slice) may be associated with a different set of policies or priorities that are used by the profile matching engine 116 in determining the matching resource management profile. For instance, a storage slice may be associated with a resource management profile that optimizes storage resources, but does not priorities latency, bandwidth, and may use a particular type of hardware that is an efficient or effective use of the network resources 104.

In the illustrated example, the profile matching engine 116 identifies the matching profile 212 based on the profile matching engine 116 determining that the matching profile 212 includes a set of deployment instructions that best match the service requirements indicated within the received network slice 208. As shown in FIG. 2, upon identifying the matching profile 212, the profile matching engine 116 provides profile data 214 to a deployment manager 118 for further processing.

As discussed above, the deployment manager 118 may facilitate rollout of network functions on the network resources 104. In one or more embodiments, the deployment manager 118 initiates, prepares, or otherwise facilitates rollout of a deployment by generating deployment instructions 216. In this example, the deployment manager 118 may generate and provide the deployment instructions 216 to the network resources 104 to facilitate allocation of deployment of network functions on the respective network resources 104.

In one or more embodiments, the deployment instructions are obtained from within the matching profile 212. In one or more embodiments, the deployment manager 118 generates the deployment instructions based on the information contained within the matching profile 212. In either example, the deployment instructions may indicate certain tags, optimizations, locations, and other criteria associated with deploying network functions in a manner that would satisfy the requirements identified within the network slice 208 when the network functions are ultimately deployed on the network resources 104.

The deployment instructions 216 may refer to a variety of instructions related to immediately or eventually rolling out network functions to be deployed on the network resources 104. In one or more embodiments, the deployment instructions 216 include instructions associated with allocating resources and causing network functions to be onboarded to the allocated resources. In one or more embodiments, the deployment instructions 216 simply identify network functions and associated configurations that may be used in satisfying a particular request or reconciling a state of a deployment with an indicated goal state of a particular deployment request. In one or more embodiments, the deployment manager 118 initiates a rollout of network functions in accordance with the deployment instructions 216 or, in some cases, simply adds the deployment instructions 216 to a queue of instructions to be performed at a later time.

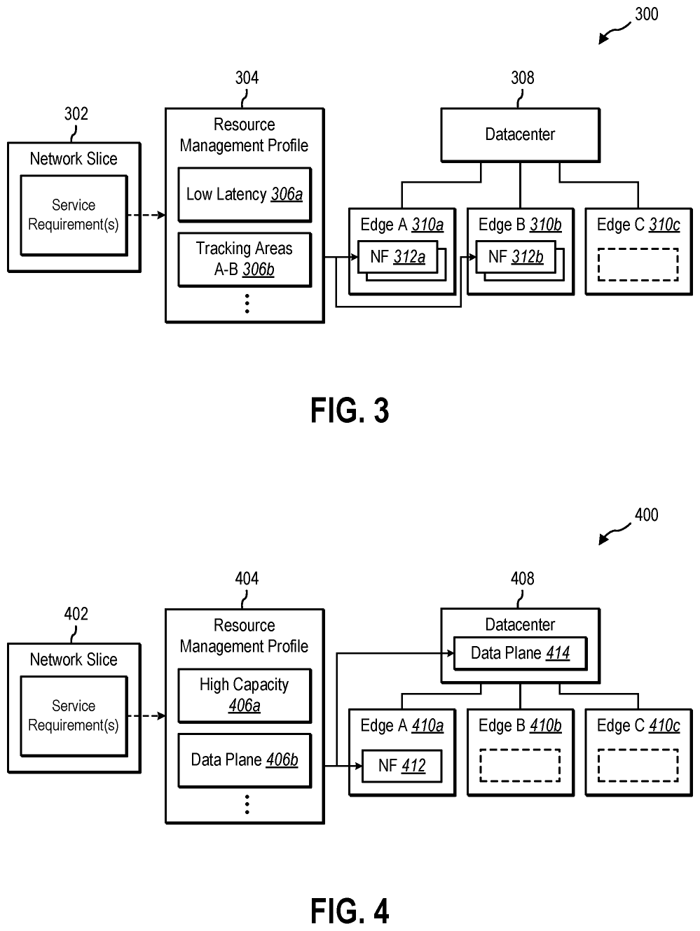

As discussed above, the slice-driven request management system 108 can generate and implement a wide variety of resource management profiles having a variety of instructions associated with resource tags and which satisfy a variety of service requirements as indicated in received network slices. As further discussed, the resource tags may refer to different characteristics associated with respective network resources. As discussed below, FIGS. 3-4 provide two illustrative examples of how different resource management profiles may be used in processing different types of slice profiles in generating and implementing deployment instructions that optimize network resources while fulfilling service requirements of network slices.

FIG. 3 illustrates a first example workflow 300 in which an example resource request is received that contains a network slice 302 for a corresponding type of service (denoted as Service A). In this example, the network slice 302 is received indicating the type of service and/or one or more service requirements that need to met to satisfy parameters of the service request. Similar to one or more embodiments described herein, the service requirements may indicate a type of service, certain parameters or network features, or other service requirements that can be indicated within the standards framework of the network slice 302.

Similar to one or more embodiments described above, the slice-driven request management system 108 may identify a matching profile 304 having one or more instructions 306a-b included therein. In this example, the matching profile 304 includes a first instruction 306a indicating a parameter to deploy network functions on resources that provide a low latency (e.g., lower than a threshold latency) quality of service. In addition, the matching profile 304 includes a second instruction 306b indicating certain areas (A-B) (e.g., deployment areas, edge locations) on which network functions should be deployed. While not shown in FIG. 3, the matching profile 304 may include other preferences or instructions that may be used in generating deployment instructions for rolling out network functions on a set of resources.

As shown in FIG. 3, the network resources may include a hierarchy of resources including (by way of example) a datacenter 308 and a plurality of edge networks 310a-con which network functions may be deployed in response to the network slice 302. In this example, the slice-driven request management system 108 may generate deployment instructions responsive to the network slice to rollout a first set of network functions 312a on a first edge network (denoted as Edge A) and a second set of network functions 312b on a second edge network (denoted as Edge B). The number and size of the network functions may be indicated within the network slice and/or by the instructions included within the matching profile 304.

FIG. 4 illustrates a second example workflow 400 in which an example resource request is received that contains a network slice 402 for a corresponding type of service (denoted as Service B). In this example, the network slice 402 is received indicating the type of service and/or one or more service requirements that need to be met to satisfy parameters of the service request. The parameters of the network slice 402 may be similar to the network slice 302 discussed above in connection with FIG. 3.

Similar to examples discussed above, the slice-driven request management system 108 may identify a matching profile 404 having instructions 406a-b included therein. In this example, the matching profile 404 includes a first instruction 406a indicating a preference or parameter that a network function be a high-capacity network function (e.g., a network function having a storage or processing capacity above a threshold capacity). The matching profile 404 additionally includes a second instruction 406b indicating a particular data plane function that may be deployed to satisfy a particular requirement(s) of the network slice 402. Similar to the matching profile 304 of FIG. 3, the matching profile 404 may include additional preferences or instructions.

FIG. 4 illustrates a similar hierarchy of resources as discussed above in connection with FIG. 3, including a datacenter 408 and a plurality of edge networks 410a-c on which network functions may be deployed in response to the network slice 402. In this example, the slice-driven request management system 108 generates deployment instructions respective to the network slice 402 to rollout a first network function 412 on a first edge network 410a. A data plane function 414 may be deployed on the data center 408 in accordance with the network slice 402 and/or instructions of the matching profile 404.

It will be appreciated that the specific placement of the network functions may be aided or guided by the instructions included within the resource management profiles based on known tags that have been previously associated with the respective network resources. In one or more embodiments, the specific location may be unspecified or indicated as neutral in the resource management profile allowing for flexible placement of the network functions on particular resources based on availability or optimizing fragmentation and other deployment metrics on the cloud computing system or telecommunications network. For instance, in the example shown in FIG. 4 (in contrast to FIG. 3), the network function 412 may be placed on the first edge network based on availability of resources on the first edge network 410a and/or based on lack of availably on other edge networks 410b-c. Similarly, the placement of the data plane 414 on the datacenter 408 may be based on specific instructions or based on a determination that edge network resources should be preserved, and a lack of latency requirement favors placement of the network function on the more centrally located datacenter 408.

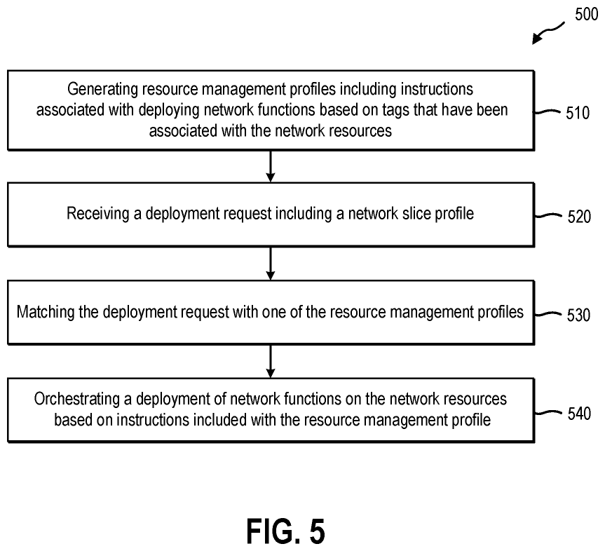

Turning now to FIG. 5, this figure illustrates an example flowchart including series of acts for tagging network resources, managing resource management profiles, and processing received resource requests based on a slice profile and the tags associated with the respective network resources. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device (e.g., input device, gaming console, client device) to perform the acts of FIG. 5. In still further embodiments, a system can perform the acts of FIG. 5.

As noted above, FIG. 5 illustrates a series of acts 500 related to tagging network resources, managing resource management profiles, and processing received resource requests based on a slice profile and tags associated with the network resources. As shown in FIG. 5, the series of acts 500 includes an act 510 of generating resource management profiles including instructions associated with deploying network functions based on tags that have been associated with network resources. In one or more embodiments, the act 510 includes generating a plurality of resource management profiles including instructions associated with deploying network functions, the instructions of the resource management profiles being determined based on tags that have been associated with network resources on a cloud computing system. In one or more embodiments, the network resources on the cloud computing system include network functions on a core network of a fifth generation (5G) telecommunications network.

As further shown in FIG. 5, the series of acts 500 includes an act 520 of receiving a deployment request including a network slice profile. In one or more embodiments, the act 520 includes receiving a deployment request, the deployment request including a network slice profile indicating one or more service requirements associated with fulfilling the deployment requests. In one or more embodiments, the network slice profile includes service requirement information in accordance with 3GPP standards.

As further shown in FIG. 5, the series of acts 500 includes an act 530 of matching the deployment request with one of the resource management profiles. In one or more embodiments, the act 530 includes matching the deployment request with a resource management profile from the plurality of resource management profiles. In one or more embodiments, matching the deployment request with the resource management profile is based on a tracking location indicated within the deployment request matching a corresponding one or more tracking locations indicated within the resource management profile.

As further shown in FIG. 5, the series of acts 500 includes an act 540 of orchestrating a deployment of network functions on the network resources based on instructions included within the resource management profile. In one or more embodiments, the act 540 includes orchestrating a deployment of network functions on the cloud computing system responsive to the deployment request based on instructions included within the resource management profile.

In one or more embodiments, the series of acts 500 includes tagging resources of the cloud computing system. In one or more embodiments, tagging resources includes tagging a new resource when onboarded to the cloud computing system. In one or more embodiments, tagging resources includes associating tags with currently deployed resources on the cloud computing system.

In one or more embodiments, the series of acts 500 includes associating one or more preferences with a requesting entity. In one or more implementations, matching the deployment request with the resource management profile is based at least in part on the one or more preferences of the requesting entity that provided the request.

In one or more embodiments, matching the deployment request with the resource management profile is based on the network slice profile including a low latency requirement. In one or more implementations, the low latency requirement is satisfied based on the resource management profile including instructions to use greater than or equal to a threshold number of small network functions distributed across multiple areas (e.g. deployment areas).

In one or more embodiments, matching the deployment request with the resource management profile is based on the network slice profile including a high-capacity requirement. In one or more implementations, the high-capacity requirement is satisfied based on the resource management profile including instructions to use a single high capacity network function.

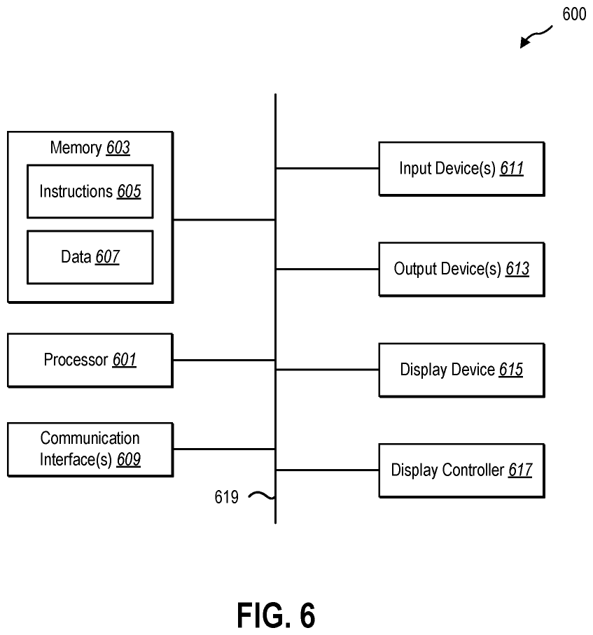

FIG. 6 illustrates certain components that may be included within a computer system 600. One or more computer systems 600 may be used to implement the various devices, components, and systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and light pen (or light-sensitive wand). Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a telecommunications network, a method for managing deployment of network functions based on received network slice profile information, the method comprising:
generating a plurality of resource management profiles including instructions associated with deploying network functions, the instructions of the resource management profiles being determined based on tags that have been associated with network resources on a cloud computing system;
receiving a deployment request, the deployment request including a network slice profile indicating one or more service requirements associated with fulfilling the deployment requests;
matching the one or more service requirements of the network slice profile included within the deployment request to a resource management profile from the plurality of resource from the plurality of resource management profiles; and
orchestrating a deployment of network functions on the cloud computing system responsive to the deployment request based on instructions included within the resource management profile.

2. The method of claim 1, further comprising tagging resources of the cloud computing system.

3. The method of claim 2, wherein tagging resources includes tagging a new resource when onboarded to the cloud computing system.

4. The method of claim 2, wherein tagging resources includes associating tags with currently deployed resources on the cloud computing system.

5. The method of claim 1, wherein the network slice profile includes service requirement information in accordance with 3GPP standards.

6. The method of claim 1, wherein matching the deployment request with the resource management profile is based on a tracking location indicated within the deployment request matching a corresponding one or more tracking locations indicated within the resource management profile.

7. The method of claim 1, further comprising associating one or more preferences with a requesting entity, wherein matching the deployment request with the resource management profile is based at least in part on the one or more preferences of the requesting entity that provided the request.

8. The method of claim 1, wherein matching the deployment request with the resource management profile is based on the network slice profile including a low latency requirement, and wherein the low latency requirement is satisfied based on the resource management profile including instructions to use greater than or equal to a threshold number of small network functions distributed across multiple areas.

9. The method of claim 1, wherein matching the deployment request with the resource management profile is based on the network slice profile including a high-capacity requirement, and wherein the high-capacity requirement is satisfied based on the resource management profile including instructions to use a single high capacity network function.

10. The method of claim 1, wherein the network resources on the cloud computing system comprise network functions on a core network of a fifth generation (5G) telecommunications network.

11. In a telecommunications network, a system for managing deployment of network functions based on received network slice profile information, the system comprising:
at least one processor;
memory in electronic communication with the at least one processor; and
instructions stored in the memory, the instructions being executable by the at least one processor to:
generate a plurality of resource management profiles including instructions associated with deploying network functions, the instructions of the resource management profiles being determined based on tags that have been associated with network resources on a cloud computing system;
receive a deployment request, the deployment request including a network slice profile indicating one or more service requirements associated with fulfilling the deployment requests;
match the deployment request with a resource management profile from the plurality of resource management profiles; and
orchestrate a deployment of network functions on the cloud computing system responsive to the deployment request based on instructions included within the resource management profile.

12. The system of claim 11, further comprising instructions being executable by the at least one processor to tag resources of the cloud computing system, wherein tagging resources includes one or more of:
tagging a new resource when onboarded to the cloud computing system; or
associating tags with currently deployed resources on the cloud computing system.

13. The system of claim 11, wherein matching the deployment request with the resource management profile is based on a tracking location indicated within the deployment request matching a corresponding one or more tracking locations indicated within the resource management profile.

14. The system of claim 11, wherein matching the deployment request with the resource management profile is based on the network slice profile including a low latency requirement, and wherein the low latency requirement is satisfied based on the resource management profile including instructions to use greater than or equal to a threshold number of small network functions distributed across multiple areas.

15. The system of claim 11, wherein matching the deployment request with the resource management profile is based on the network slice profile including a high-capacity requirement, and wherein the high-capacity requirement is satisfied based on the resource management profile including instructions to use a single high-capacity network function.

16. In a core network implemented at least in part on an edge network of a cloud computing system, a method for managing deployment of network functions based on received network slice profile information, the method comprising:
tagging resources of the core network with a plurality of tags indicating characteristics of network resources on the core network, the core network being implemented across one or more edge networks of a cloud computing system;
generating a plurality of resource management profiles including instructions associated with deploying network functions in the core network, the instructions of the resource management profiles being determined based on the plurality of tags that have been associated with the network resources on the core network;
receiving a deployment request, the deployment request including a network slice profile indicating one or more service requirements associated with fulfilling the deployment requests;
matching the deployment request with a resource management profile from the plurality of resource management profiles; and
orchestrating a deployment of network functions on the core network responsive to the deployment request based on instructions included within the resource management profile.

17. The method of claim 16, wherein tagging the resources of the core network includes one or more of:
tagging a new resource when onboarded to the cloud computing system; or associating tags with currently deployed resources on the cloud computing system.

18. The method of claim 16, wherein matching the deployment request with the resource management profile is based on a tracking location indicated within the deployment request matching a corresponding one or more tracking locations indicated within the resource management profile.

19. The method of claim 16, wherein matching the deployment request with the resource management profile is based on the network slice profile including a low latency requirement, and wherein the low latency requirement is satisfied based on the resource management profile including instructions to use greater than or equal to a threshold number of small network functions distributed across multiple areas.

20. The method of claim 16, wherein matching the deployment request with the resource management profile is based on the network slice profile including a high-capacity requirement, and wherein the high-capacity requirement is satisfied based on the resource management profile including instructions to use a single high-capacity network function.
